(19) United States
(12) Patent Application Publication
(10) Pub. No.: US 2003/0126248 A1
(43) Pub. Date: Jul. 3, 2003

(54) Method to automatically configure network routing device

(76) Inventor: Paul S. Chambers, San Jose, CA (US)

Correspondence Address: Corporate Patent Counsel, U.S. Philips Corporation, 580 White Plains Road, Tarrytown, NY, 10591, US

(21) Appl. No.: 10/034,664

(22) Filed: Dec. 28, 2001

(51) Int. Cl. G06F 15/173

(52) U.S. Cl. 709/223

(57) ABSTRACT

A home network has a data processing device and a network access device for access to an external network. When a new device is added the network is to be configured. Configuration is done as follows. The communication between the data processing device and the access device is monitored. Then, information is extracted from the communication about protocols and external network addresses. The home network can then be configured automatically based on the information extracted.

### FIELD OF THE INVENTION

The invention relates to configuring a routing functionality on a network, e.g., a home network.

### BACKGROUND ART AND SUMMARY OF THE INVENTION

A router is a software or hardware functionality to connect segments of data networks. Some cable/DSL routers are designed to enable users to link the Internet to their own private LAN. These routers typically include NAT (Network Address Translation) capability, which allows multiple computers to access the Internet using a single public IP address. A router functions as a sorter and interpreter as it looks at IP addresses and passes bits of information to their proper destinations.

A firewall is a system designed to prevent unauthorized access to a private network. A firewall can be implemented in hardware, in software or using a combination thereof.

A gateway refers to hardware or software that performs an application layer conversion of information from one protocol stack to another.

A sniffer or packet sniffer is a software program or a hardware device that eavesdrops on network traffic. Typically, a sniffer is being used by professional operators for maintenance of the network, e.g., to discover problems in the data communication between computers, to discover network bottlenecks, to detect network intrusion, etc. Sniffers are also used by hackers, e.g., to spot clear-text passwords or to convert data to legible text format. A sniffer may also perform protocol analysis, content searches or content matches.

The invention relates to a method for providing routing, gateway, firewall or similar services to existing networks. According to the invention, data traffic between the networks is initially monitored, e.g., between a home network and the Internet. For example, the data traffic is monitored between an Internet appliance (e.g., a PC) on the home network and an Internet access device (e.g., a modem). A sniffer can be used for this task. The monitoring enables to extract information from this data communication, the information being relevant to configuring an interface between the Internet access device and the Internet appliance. Once sufficient information has been extracted, this information is used to configure the interface between the appliance and the access device. The interface is configured, e.g., manually through instructions to the user on how to set up the Internet appliance to have it work with the interface, given the extracted information. Alternatively, downloadable software is made available to have the appliance set up automatically. In this manner, the interface is set up to function as a router or firewall.

Further, the extracted information can be used to make the interface appear to be the Internet access device as seen from the Internet appliance, and as the Internet appliance as seen from the Internet access device. In this case, no reconfiguration of the appliance is necessary. More appliances may now be added on the user's home network, using network address translation (NAT) or similar techniques, to make them appear to be a single appliance on the Internet. The interface can also have a DHCP server functionality to dynamically assign IP addresses to the appliances on the home network.

### BRIEF DESCRIPTION OF THE DRAWING

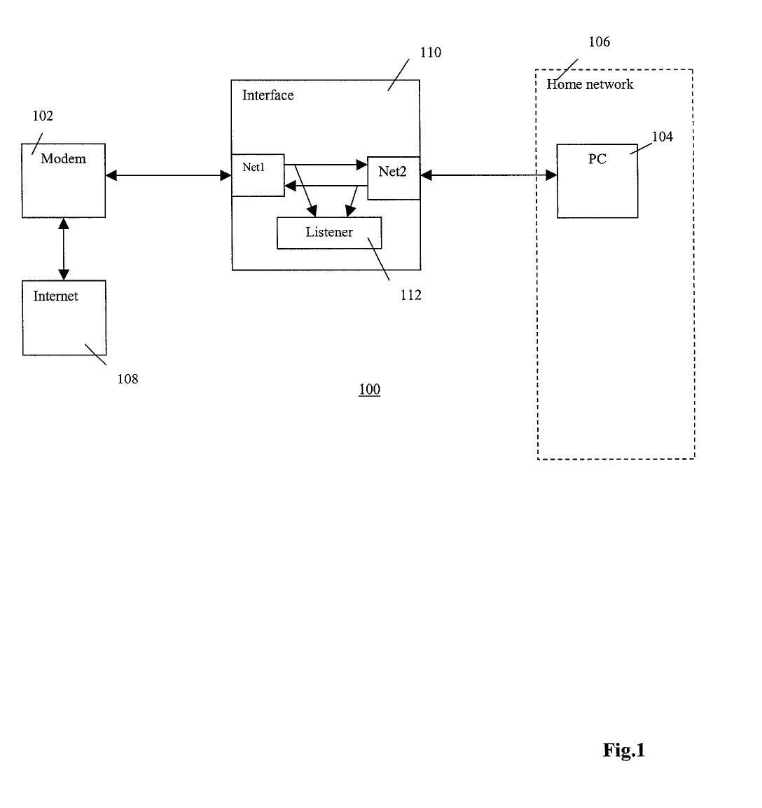

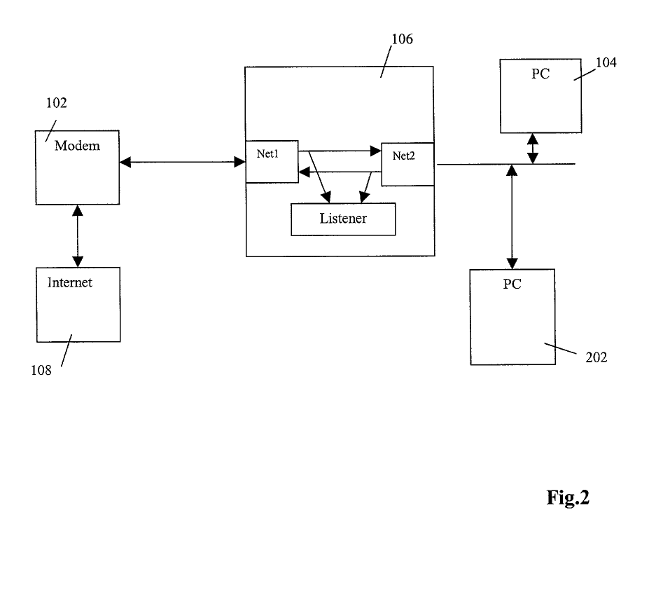

The invention is explained in further detail below, by way of example, and with reference to the accompanying drawing, wherein FIGS. 1 and 2 are block diagrams of a system in the invention. Throughout the figures, same reference numerals indicate similar or corresponding features.

### DETAILED EMBODIMENTS

FIG. 1 is a block diagram of a system 100 in the invention. System 100 comprises an Internet access device 102 and a local network device 104 on a home network 106. Internet access device 102 enables data communication between home network 106 and the Internet 108. For example, device 102 comprises a broadband modem. Local network device 104 comprises, e.g., a PC, an STB or an Internet Appliance. An interface device 110 is inserted between modem 102 and PC 104. Interface device 110 is going to be configured as a router as explained below. Typically, a router monitors the destination addresses of the data packets passing through and decides where to send them based on these destination addresses. Routers bridge networks but, in addition, are capable of filtering messages and forward them to different places or block them based on various criteria.

Interface device 110 connects modem 102 and PC 104 and thus enables data communication between the Internet 108 and local device 104. Initially, interface device 110 operates in the “eavesdrop” mode as it listens to the packets passing through, as if it were a sniffer. In the “eavesdrop mode”, device 110 is transparent to the network packets. Interface device 110 has a listener 112 that copies information from the packets to determine the protocols being used in the communication between device 104 and the Internet 108 that are relevant to the configuration of interface device 110, e.g., as a firewall, as a router, etc. For example, interface device 110 collects information about the IP address used by the local network device, whether it is a static address or is obtained from the Internet access device (via DHCP, for example). It collects parameters necessary to log into a PPPoE connection (Point-to-Point Protocol over Ethernet), if that protocol is in use. It may observe email connections, and obtain POP3 and SMTP information for the email configuration. It could observe DNS queries, and determine at least one DNS server address (if this information is not already provided by DHCP). Once interface device 110 has collected sufficient information, it is able to configure its parameters and switch from “eavesdrop” mode to “operating” mode. That is, interface device 110 can start functioning as a firewall, as a router, etc. As to collecting sufficient information, this sufficiency refers in particular to finding out which protocols are being used below the transport level: e.g., PPPoE, DHCP, DNS, etc., as mentioned above. As there exists only a limited number of protocols, monitoring the traffic for a short period while the user connects to their Internet service provider should be sufficient. Alternatively, the user can be notified of the purpose of the eavesdropping and be asked to use the whole set of his/her software applications that communicate via the modem. Conventionally, the information about the protocols and addresses being used is collected by an installer to configure the system manually, e.g., by manually checking off items in the installation menu and manually entering the proper addresses, paths, etc. In the invention, the information for the installation menu is gathered automatically for being entered in the installation menu, e.g., automatically or manually by the user with the help of a guiding program.

Once interface device 110 enters the “operating” mode, it initially intercepts any connections made by the local network device 104 using the HTTP protocol (used by web browsers to retrieve web pages) and routes it to an internal web server. The preferred embodiment locates this server in interface device 110. Alternatively, it can be located on PC 104 or be provided via an application server on the Internet. This web server may provide written instructions for the user on how to configure local network device 104 to work with interface device 110 (tailored to the configuration already detected). The web server may also offer downloadable software (plug-in or application), which is able to automatically do the reconfiguration on the user's behalf. Once the reconfiguration has occurred, interface device 110 stops intercepting HTTP connections. Thus, interface device 110 has assumed the role of a firewall.

Alternatively or supplementarily, interface device 110 may assume the role of Internet access device 102 as seen from local network device 104, and the role of local network device 104 as seen from Internet access device 102, using network address translation (NAT) or similar techniques. In this case, no reconfiguration of local network device 104 is necessary. As illustrated in FIG. 2, more devices, e.g., a PC 202 may now be added on home network 106, using NAT to make them appear to be a single device on the Internet 108. Thus, devices on home network 106 can use a single IP address for communication with the external network. As known, a certain range of IP addresses is strictly reserved for use on private (internal) networks, e.g., 10.x.x.x and 192.168.x.x, wherein <x> stands for an integer between zero and 255, in accordance with IP address numbering rules.

Incorporated herein by reference is U.S. Pat. No. 6,314,459, issued Nov. 6, 2001 for Lawrence Freeman for HOME-NETWORK AUTOCONFIGURATION. This document relates to automatically configuring PCs in a network in order to share resources registered at the individual PCs. Services and resources local to one PC are registered with the other PC and vice versa. The registry hides whether a service or resource is remote or local. In operational use of the network, a resource or service local to one PC is addressable from the remote PC as if it were local to the latter. A home network of PCs is configured automatically in this manner.

What is claimed is:

1. A method of enabling to configure a home network that has a data processing device and a network access device for access to an external network, the method comprising:
monitoring communication between the data processing device and the access device;
from the communication monitored extracting information for configuring the home network.

2. The method of claim 1, further comprising configuring the home network based on the information extracted.

3. The method of claim 1, comprising guiding a user how to configure the home network based on the information extracted.

4. The method of claim 1, wherein the information extracted comprises an indication of one or more protocols below the transport level being used in the communication.

5. Software for configuring a home network, wherein the home network has a data processing device and a network access device for access of an external network, the software comprising:
a monitor for monitoring communication between the data processing device and the access device; and
a configuration program for configuring the home network based on information extracted from the communication monitored.

6. The software of claim 5 wherein the configuration program automatically configures the home network.

7. The software of claim 5, wherein the configuration program guides a user through configuring the home network based on the information extracted.

8. An electronic apparatus for configuring a home network, wherein the home network has a data processing device and a network access device for access of an external network, the apparatus comprising:
a monitor for monitoring communication between the data processing device and the access device; and
a configuration program for configuring the home network based on information extracted from the communication monitored.
